(19) United States
(12) Patent Application Publication
(10) Pub. No.: US 2024/0276943 A1
(43) Pub. Date: Aug. 22, 2024

(54) METHOD AND SYSTEM FOR AREA WARMING OF AN ANIMAL CAGE

(71) Applicant: Allentown LLC, Allentown, NJ (US)

(72) Inventors: John Coiro, Princeton, NJ (US); Steve Miller, Cream Ridge, NJ (US); Isagani Semira, Neptune, NJ (US)

(21) Appl. No.: 18/422,489

(22) Filed: Jan. 25, 2024

Related U.S. Application Data
(60) Provisional application No. 63/441,254, filed on Jan. 26, 2023.

(51) Int. Cl. A01K 1/00

(52) U.S. Cl. CPC A01K 1/0076

(57) ABSTRACT

A system for warming an animal cage including a warming plate supported or coupled in a plate housing. The warming plate can be spring loaded to ensure the warming plate is in constant contact with a received removable cage. The plate housing can include a docking system for removably supporting the plate housing on a runner system of a caging rack system. The docking system allows the plate housing to be expeditiously removed from the caging rack system for ergonomic cleaning and washing of the plate housing and warming plate.

### BACKGROUND OF THE INVENTION

### Field of the Invention

The present invention relates in general to method and system for warming an area of an animal cage and in particular to a warming plate in contact with the animal cage docked in a caging rack system.

### Description of Related Art

Heating of animal cages has conventionally been performed by heating of the environment of the cages or placing a heating element within the cage.

It is desirable to provide an improved method and system for warming an animal cage by removably docking a warming plate in contact with animal cage in which both the warming plate and the animal cage can be expeditiously retained and removed from a caging rack system.

### SUMMARY OF THE INVENTION

The present invention relates to a method and system for warming an animal cage in which a warming plate is configured to contact a removable animal cage. In one embodiment, the warming plate is supported in a plate housing or coupled to the plate housing. The warming plate can be biased within the plate housing to ensures that the warming plate is in constant contact with the removable cage regardless of tolerancing. The plate housing can include a docking system for a caging rack system. The plate housing can include side protrusions or flanges to removably support the plate housing on a runner system of a caging rack system. The docking system allows the plate housing to be expeditiously removed from the caging rack system for ergonomic cleaning and washing of the plate housing and warming plate.

The warming plate can have a contact area with the animal cage in the range of about 10 to 80% of the base area of the animal cage. In one embodiment the warming plate has a contact area of 50% of the base area of the animal cage.

The plate housing can include a power switch for activating the warming plate. The plate housing can include a power on indicator. In one embodiment, the power on indicator is a green LED. The plate housing can include a heater active indicator. In one embodiment, the heater active indicator is a red LED.

The warming plate can be formed of metal and powered by a voltage to heat the warming plate. A controller can be used to provide adjustment of the temperature of the warming plate. For example, the warming plate can be used at 115 V AC input.

The removable animal cage can be a free-standing cage assembly constructed of a cage base and a cage top. The animal cage can be used with rodent animals or similar sized species. The cage base comprises walls extending from a floor. The walls can be integral with the floor. The cage top comprises walls extending from a ceiling or a flat top. The cage base and the cage top can be constructed of a polymer. The cage base and the cage top can be removably attached to one another.

In one embodiment, the cage base and cage top can be snap fitted to one another. A top edge of the cage base extending from the cage base creates a suspended runner system allowing the animal cage to be installed on rows of the caging rack system to automatically lock the cage top and cage base together. The caging rack system can be a ventilated rack or a static air rack. The docking system can be spring loaded to ensure contact of the warming plate with the cage upon insertion of the animal cage into the rack.

The invention will be more fully described by reference to the following drawings.

### BRIEF DESCRIPTION OF THE DRAWINGS

FIG. 1 is a perspective view of a system for warming an animal cage including a plate housing and warming plate.

FIG. 2 is a front and top view of the system for area warming of an animal cage.

FIG. 3 is a front an top view of the system for area warming of an animal cage supported on a runner system of a caging rack system.

FIG. 4 is a perspective view of the system for area warming of an animal cage supported in a runner system of a caging rack system and in contact with an animal cage.

FIG. 5 is a front perspective view of the system for area warming of an animal cage supported in a runner system of a caging rack system and in contact with an animal cage.

FIG. 6 is a perspective view of a system for warming an animal cage including a plate housing and warming plate.

FIG. 7 is an exploded view of the system shown in FIG. 6.

FIG. 8 is a cross-sectional side view of the system shown in FIG. 6.

Embodiments of the present disclosure and their advantages are best understood by referring to the detailed description that follows. It should be appreciated that the figures may not be necessarily drawn to scale.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

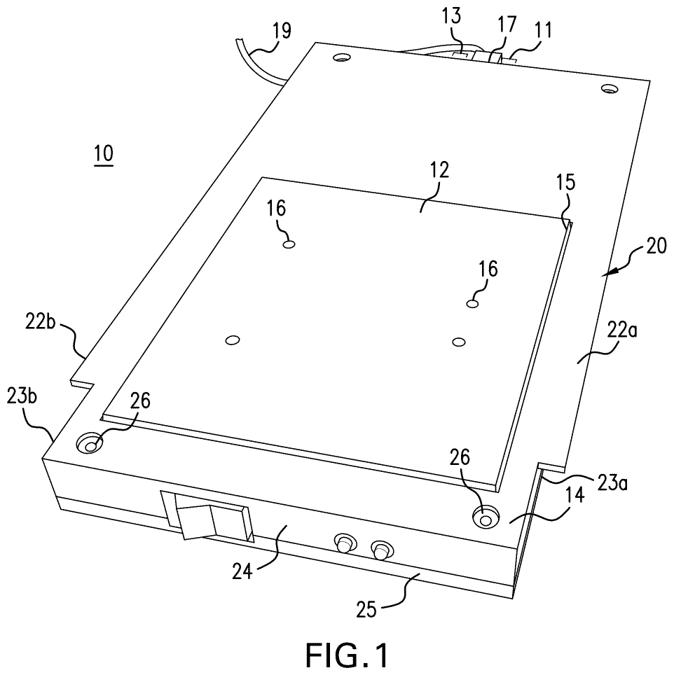

FIG. 1 illustrates system for area warming of an animal cage 10 in accordance with the teachings of the present invention. Warming plate 12 is supported in plate housing 14. In one embodiment warming plate 12 is supported in plate housing indentation 15 of plate housing 14. Plate housing indentation 15 can have a size corresponding to warming plate 12. Warming plate 12 can be spring loaded and sized to fit within plate housing indentation 15 of plate housing 14 to ensure contact with a cage received on warming plate 12. Warming plate 12 can include protrusions 16 for coupling to plate housing 14. In an alternative embodiment, warming plate 12 can be integral with plate housing 14. Power outlet 17 can be positioned at rear 18 of plate housing 14. Power outlet 17 can be coupled to power cord 19. Switch 11 can be activated to turn on and off power outlet 17.

Warming plate 12 can be formed of metal and powered by a voltage from power outlet 17 to heat warming plate 12. Controller 13 associated with power outlet 17 can be used to provide adjustment of the temperature of warming plate 12. For example, warming plate 12 can be used at 115 V AC input.

In one embodiment, plate housing 14 includes docking system 20 configured for inserting of plate housing 12 into a caging rack system. Docking system 20 includes side flanges 22a, 22b extending on either respective side 23a, 23b of plate housing 14.

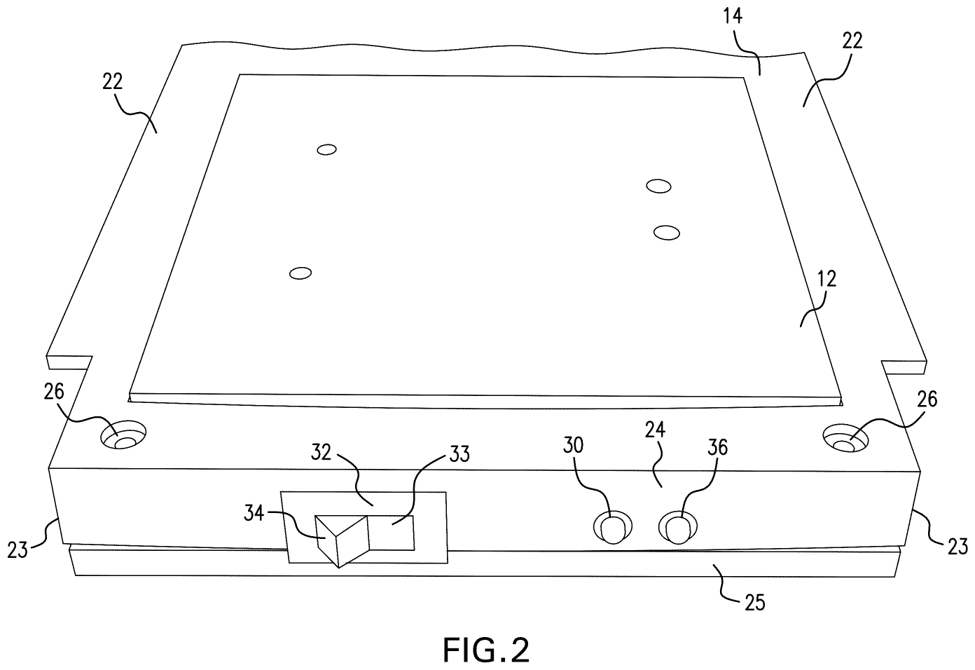

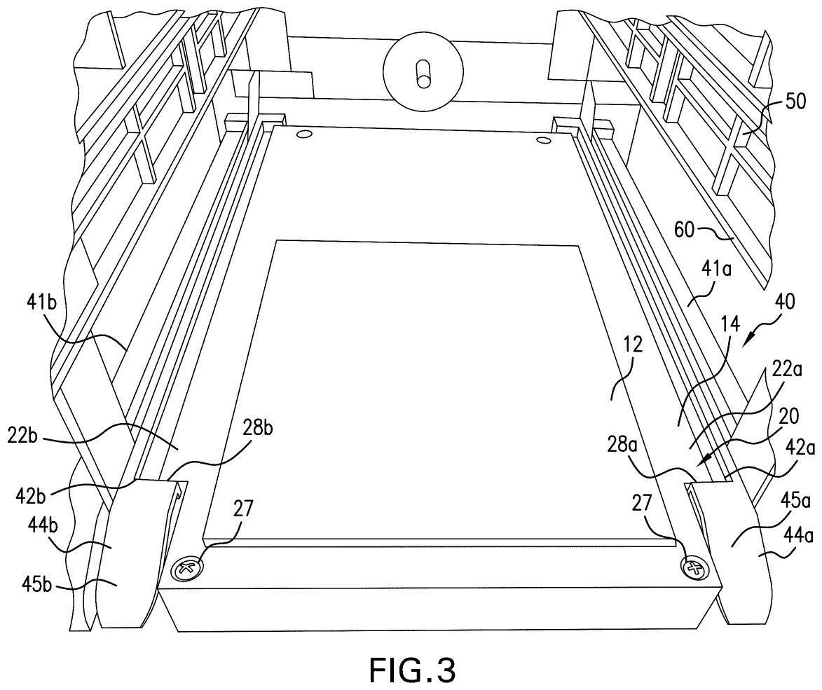

Referring to FIG. 2, plate housing 14 can be formed of upper housing 24 and lower housing 25. Upper housing 24 can include indentations 26. A coupling member can be received in indentations 26 for coupling upper housing 24 to lower housing 25. For example, the coupling member can be screw 27 as shown in FIG. 3.

Referring to FIG. 2, plate housing 12 can include power on indicator 30. In one embodiment, power on indicator 30 is a green LED. Power on indicator 30 is activated by turning on switch 11 shown in FIG. 1.

Plate housing 14 can include heater power switch 32 for activating warming plate 12 as shown in FIG. 2. Heater power switch 32 can be moved between off position 33 and on position 34. Plate housing 14 can include heater active indicator 36. In one embodiment, heater active indicator 36 is a red LED. Heater active indicator 36 is activated by turning heater power switch 32 to on position 34.

Referring to FIG. 3, docking system 20 removably supports plate housing 14 on runner system 40 and allows plate housing 14 to be expeditiously removed from caging rack system 50 for ergonomic cleaning and washing of plate housing 14 and warming plate 12. Runner system 40 includes runners 41a and 41b. After insertion of docking system 20 onto runner system 40, side flange 22a, 22b are respectively supported by runners 41a, 41b. Runner activation member 44a is positioned at end 42a of runner 41a. Runner activation member 44b is positioned at end 42b of runner 41b. After insertion of docking system 20 onto runner system 40, runner activation member 44a is positioned adjacent end 28a of flange 22a and runner activation member 44b is positioned adjacent end 28b of flange 22b. Runner activation member 44a and runner activation member 44b in combination with docking system 20 retain plate housing 22 on respective runners 41a, 41b. Runner activation member 44a and runner activation member 44b can be spring activated. Activating runner activation member 44a by pressing on top surface 45a of runner activation member 44a and top surface 45b of runner activation member 44b can release docking system 20 from runner system 40 such that plate housing 14 can be removed from caging rack system 50.

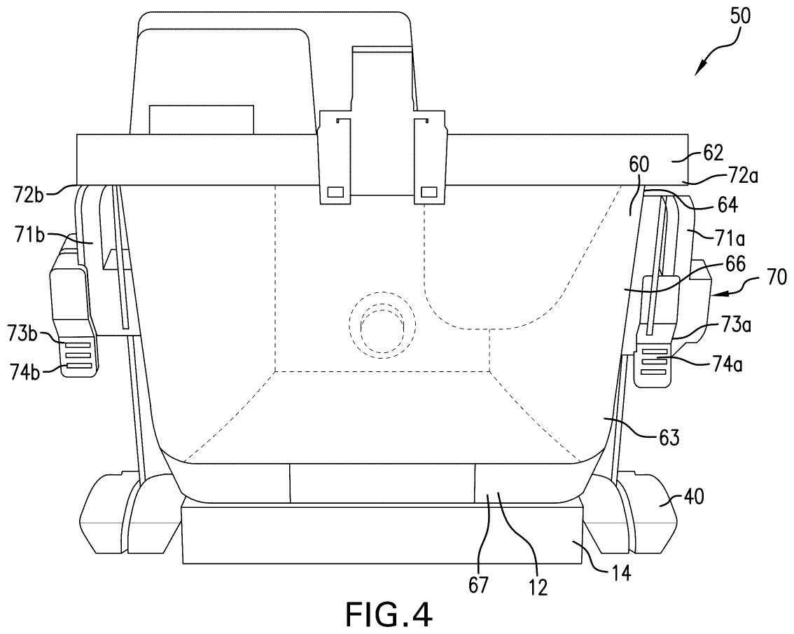

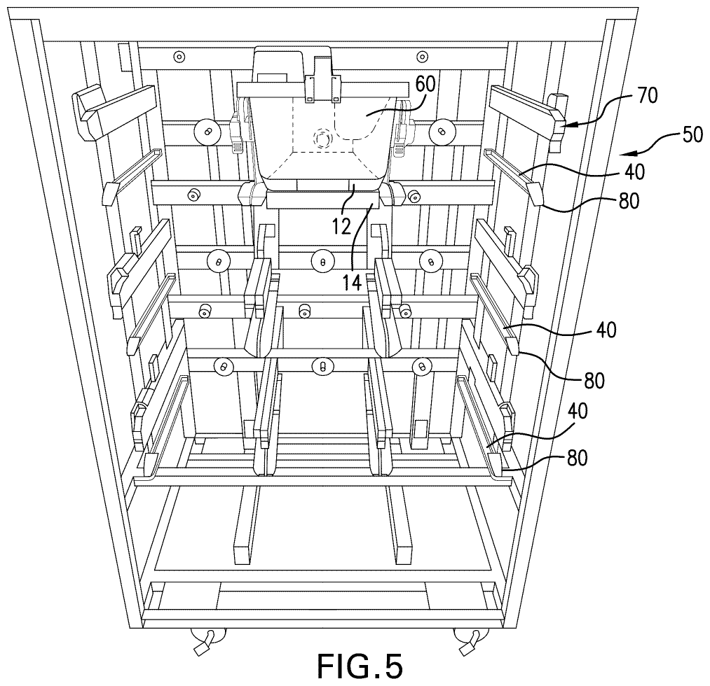

Referring to FIG. 4 and FIG. 5, animal cage 60 can be received on runner system 40 of caging rack system 50 to allow animal cage 60 to contact warming plate 12 supported by plate housing 14.

Referring to FIG. 3 and FIG. 4, warming plate 12 can have a contact area with animal cage 60 in the range of about 10 to 80% of a base surface area of animal cage 60. In one embodiment the warming plate 12 has a contact area of 50% of a base surface area of animal cage 60.

Referring to FIG. 5, individual animal cages 60 are suspended by runner system 40 and 70 on rows 80 of caging rack system 50. Alternatively, animal cages are supported on at least one shelf or platform of caging rack system 50. Animal cage 60 can include cage base 63 and cage top 62 as shown in FIG. 4. Cage base 63 includes walls 66 extending from floor 67. Walls 66 and floor 67 can be integral to one another. Cage base 63 and cage top 62 can be constructed of a polymer.

Referring to FIG. 4, top edge 64 of walls 66 can include depressions 68. Walls 66 of cage base 63 support cage top 62 in depressions 68 of top edge 64. Cage base 63 and cage top 62 can be snap fitted to one another. Top edge 64 of cage base 63 and cage top 62 extending from cage base 63 can be received within suspended runner system 70 for automatically locking cage base 63 and cage top 62 together. Cage base 63 contacts warming plate 12 supported by plate housing 14. Suspended runner system 70 can include runners 71a, 71b respectively supporting sides 72a,72b of cage top 62. Runner activation member 74a is positioned at end 73a of runner 71a. Runner activation member 74b is positioned at end 73b of runner 74a. Runner activation member 74a and runner activation member 74b retain animal cage 60 on respective runners 71a, 71b. Runner activation member 74a and runner activation member 74b can be activated to release animal cage 60 from suspended runner system 70 of caging rack system 50. Caging rack system 50 can be a ventilated rack or a static air rack. Example caging rack systems 50 are manufactured by Allentown, LLC. as Nexgen, Micro-Vent and PNC.

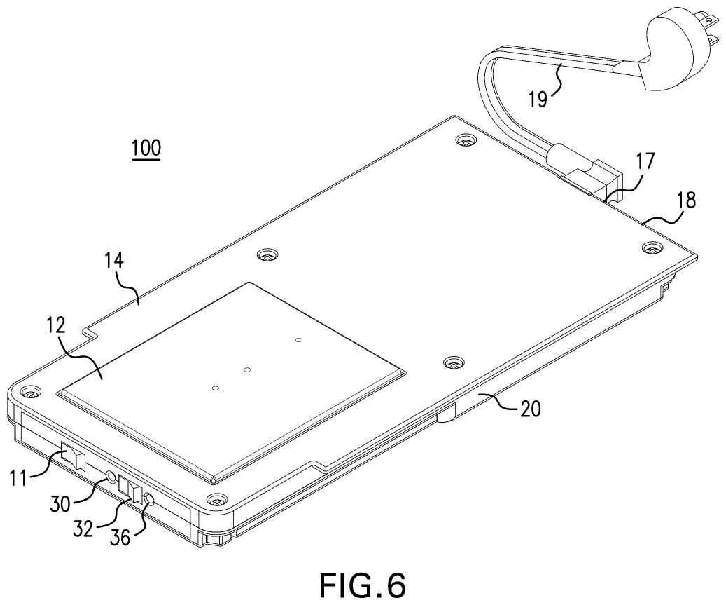

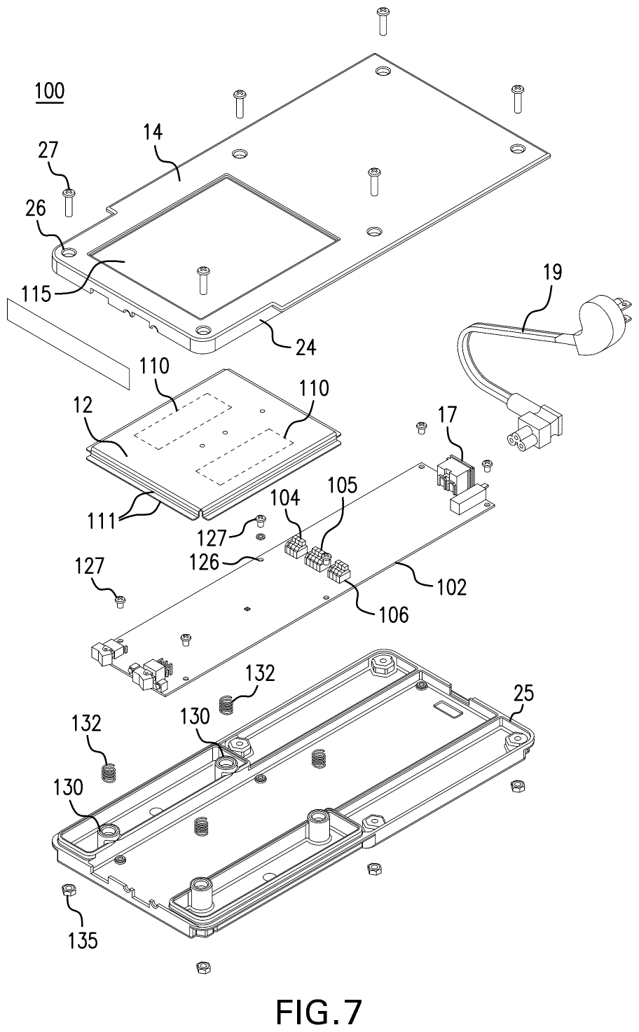

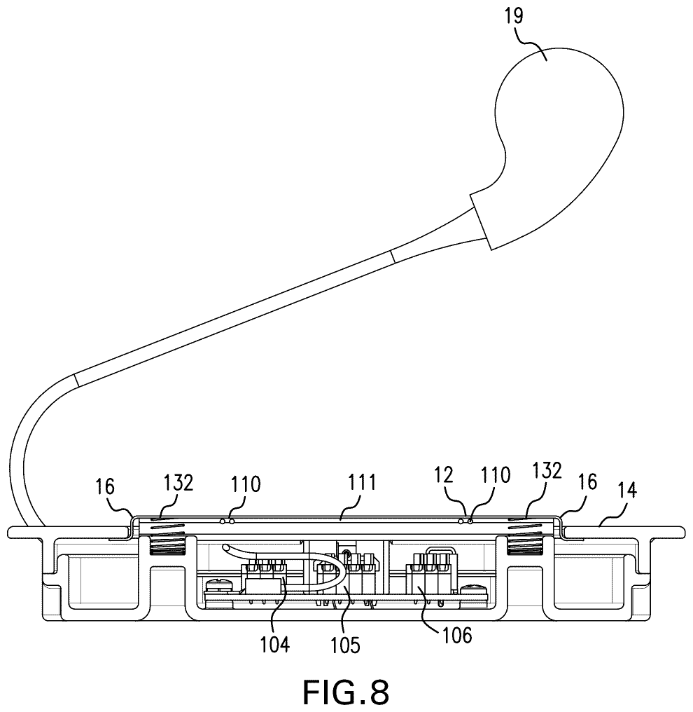

FIGS. 6-8 illustrate an embodiment of system for area warming of an animal cage 100. Electrical connections for heating elements 104, 105, 106 are coupled to support 126. Support 126 is coupled to lower housing 25 using coupling member 127 and coupling member 135. Coupling member 127 can be a screw. Coupling member 135 can be a washer. Warming plate heating elements 110 can be coupled to bottom surface 111 of warming plate 12. Warming plate elements 110 can be connected to respective heating elements 104, 105 or 106. Plate housing opening 115 can have a size corresponding to warming plate 12. Springs 132 are received in respective spring housings 130. Spring housings 130 extend from lower housing 25.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A system for warming an area of an animal cage comprising:
a warming plate supported in a plate housing or coupled to a plate housing,
wherein the plate housing is configured to receive an animal cage, a cage base of the animal cage being in contact with the warming plate.

2. The system of claim 1 wherein the plate housing includes a plate housing indention or opening, the warming plate is supported in said plate housing indention or opening.

3. The system of claim 2 wherein the warming plate incudes one or more protrusions for coupling the warming plate to the plate housing.

4. The system of claim 1 wherein the warming plate is integral with the plate housing.

5. The system of claim 1 wherein the warming plate is spring loaded within said plate housing to bias the warming plate against the received cage base of the animal cage.

6. The system of claim 1 wherein the plate housing comprises an upper housing and a lower housing, a plurality of springs being positioned between said upper housing and said lower housing, the springs bias the warming plate against the received base of the animal cage.

7. The system of claim 1 wherein the warming plate is formed of metal.

8. The system of claim 1 wherein the plate housing comprises a docking system, said docking system configured to support the plate housing in a caging rack system.

9. The system of claim 9 wherein the docking system comprises a first side flange extending from a first side of the plate housing and a second side flange extending from a second side of the plate housing, the first side flange and the second side flange configured to support the plate housing on a respective first runner and second runner of the caging rack system.

10. The system of claim 10 wherein a first runner activation member is positioned at an end of the first runner and a second runner activation member is positioned at an end of the second runner after insertion of the docking system onto the first runner and the second runner, the first runner activation member is positioned adjacent an end of the first flange and the second runner activation member is positioned adjacent an end of the second flange, wherein the first runner activation member and the second runner activation member in combination with the docking system retain the plate housing on the first runner and the second runner.

11. The system of claim 11 wherein the first runner activation member and the second runner activation member include a bias member, activating a top surface of the first runner activation member and a top surface of the second runner activation member releases the docking system from the first runner system and the second runner system to remove the plate housing from the caging rack system.

12. The system of claim of 1 further comprising a heater power switch for activating the warming plate and at least one heater active indicator, the at least one heater active indicator indicating when the warming plate is activated or not activated.

13. The system of claim 1 wherein the warming plate comprises at least one warming plate heating element positioned on a bottom surface of said warming plate.

14. The system of claim 1 wherein the warming plate has a contact area in the range of about 10% to about 80% of a base area of the animal cage.

15. The system of claim 1 wherein the warming plate has a contact area in the range of about 10% to about 80% of a base area of the animal cage.

16. A system for warming an area of an animal cage comprising:
a warming plate supported in a plate housing or coupled to a plate housing,
an animal cage, the animal cage being supported on the plate housing, a cage base of the animal cage being in contact with the warming plate; and
a rack for supporting the animal cage, the rack includes a suspended runner system for automatically locking the cage into the rack after the cage is inserted into the rack; and
a docking system comprising a first side flange extending from a first side of the plate housing and a second side flange extending from a second side of the plate housing, the first side flange and the second side flange configured to support the plate housing on a respective first runner and second runner of the suspended runner system.

17. The system of claim 16 wherein the warming plate is spring loaded within said plate housing to bias the warming plate against a cage base of the animal cage.

18. The system of claim 17 wherein the plate housing comprises an upper housing and a lower housing, a plurality of springs being positioned between said upper housing and said lower housing, the springs bias the warming plate against the received base of the animal cage.

19. The system of claim 16 wherein a first runner activation member is positioned at an end of the first runner and a second runner activation member is positioned at an end of the second runner after insertion of the docking system onto the first runner and the second runner, the first runner activation member is positioned adjacent an end of the first flange and the second runner activation member is positioned adjacent an end of the second flange, wherein the first runner activation member and the second runner activation member in combination with the docking system retain the plate housing on the first runner and the second runner.

20. The system of claim 16 wherein the first runner activation member and the second runner activation member include a bias member, activating a top surface of the first runner activation member and a top surface of the second runner activation member releases the docking system from the first runner system and the second runner system to remove the plate housing from the caging rack system.
